(19) United States
(12) Patent Application Publication
(10) Pub. No.: US 2010/0068469 A1
(43) Pub. Date: Mar. 18, 2010

(54) UNDERLAY SHEET AND METHOD FOR MANUFACTURE THEREOF

(76) Inventor: Helmut Wiemers, Kaipiainen (FI)

Correspondence Address: YOUNG & THOMPSON, 209 Madison Street, Suite 500, Alexandria, VA, 22314, US

(21) Appl. No.: 12/513,243

(22) PCT Filed: Oct. 31, 2007
(86) PCT No.: PCT/FI07/50584

§ 371 Date: Jul. 2, 2009

(30) Foreign Application Priority Data
Nov. 1, 2006 (FI) U20060454

(51) Int. Cl. E04F 15/18; B32B 3/10; B32B 38/00

(52) U.S. Cl. 428/172; 156/245

(57) ABSTRACT

An underlay sheet and a method for the manufacture thereof. The underlay sheet is substantially a uniform structure, including two layers connected to each other, the first and upper layer (3) being a film layer, and the second and lower layer (2) being a sub-layer substantially formed of one material and including a plate-like part and projections (5) arranged on the lower surface of the plate-like part at a distance from each other and in accordance with a predetermined pattern, such that grooves for the air flow are formed between the projections.

### FIELD OF THE INVENTION

The invention relates to the underlay sheet defined in the preamble of claim 1 for use under e.g. a parquet or a laminate floor, and to the method defined in the preamble of claim 7 for manufacturing an underlay sheet.

### BACKGROUND OF THE INVENTION

It is known from the prior art that a floor covered with parquet and laminate must be insulated from the base structure, this being normally a concrete structure. The concrete used as the base structure often comprises irregularities. It is known to use an underlay sheet for evening out the irregularities, for insulation and for preventing moisture exchange. One purpose of the underlay sheet is to damp the sounds of footsteps applied onto the floor from being transferred into the base structure. It is known from the prior art to form the underlay sheet of cellular plastic which is flexible and isolates the surface material of the floor from the concrete structure.

Also known from the prior art is the use of a separate vapour barrier film in conjunction with the underlay sheet to prevent moisture exchange from the base structure to the surface material of the floor.

The problem with the known solutions is that the underlay sheet material or the film material used is placed too tightly against the concrete structure, preventing the moisture exchange from the concrete structure. This prevention of moisture removal causes, at the worst, growth of mildew and impurities under the surface material of the floor.

### OBJECTIVE OF THE INVENTION

The objective of the invention is to eliminate the drawbacks referred to above. One specific objective of the invention is to disclose a new type of underlay sheet solution and a method for the manufacture thereof.

### SUMMARY OF THE INVENTION

The underlay sheet and the method for the manufacture thereof in accordance with the invention are characterized by what has been presented in the claims.

The invention is based on an underlay sheet that can be used in conjunction with a floor covering, e.g. parquet or laminate, preferably between the floor covering and the supporting base structure of the floor. In accordance with the invention, the underlay sheet is substantially a uniform structure, comprising two layers connected to each other, the first and upper layer being a film layer, and the second and lower layer being a sub-layer substantially formed of one material and comprising a plate-like part and projections arranged on the lower surface of the plate-like part at a distance from each other and in accordance with a predetermined pattern, such that grooves for the air flow are formed between the projections.

In this conjunction, underlay sheet refers to a layer of material arranged between the supporting base structure, e.g. a concrete structure, and the surface material of the floor, e.g. parquet or laminate surface.

The invention is also based on a method for manufacturing an underlay sheet. In accordance with the invention, a plate-like sub-layer is formed by compression, preferably by pressing to shape, of one material suitable for the application, and projections are arranged onto the lower surface thereof at a distance from each other in accordance with a predetermined pattern, such that grooves for the air flow are formed between the projections, and a film layer is arranged on the upper surface of the formed sub-layer and attached to the sub-layer by means of heat in order to form a uniform underlay sheet structure.

The invention is specifically based on the idea of connecting the different layers of the underlay sheet to each other in such manner that the underlay sheet will substantially be completely uniform, and forming the sub-layer of the underlay sheet substantially of one material. Preferably, the film layer of the underlay sheet is arranged on top of the sub-layer, against the upper surface of the plate-like part. The projections of the sub-layer are arranged on the lower surface of the plate-like part, so that flow channels for air are arranged on the lower surface of the underlay sheet. Preferably, the underlay sheet is arranged under the floor covering such that the floor surface rests against the film layer of the underlay sheet and the projections of the underlay sheet rest against the supporting base structure of the floor.

In one embodiment of the invention, the sub-layer is formed of flexible cellular plastic. In one embodiment, the sub-layer is formed of e.g. LDPE plastic.

In one embodiment of the invention, the film layer is formed of a suitable thin plastic film, e.g. an HDPE and LDPE film. An HDPE or LDPE film is tough and extremely wear-resistant. In one embodiment, the thickness of the film layer is about 10 to 40 μm, preferably about 20 μm.

In one embodiment of the invention, a predetermined elevated pattern is arranged on the lower surface of the sub-layer of the underlay sheet. In one embodiment, the elevated pattern is substantially regular. In one embodiment, the elevated pattern is formed of elevations oriented in one direction or two directions and repeating regularly or in series on the lower surface of the sub-layer of the underlay sheet. In one embodiment, the elevated pattern may be irregular. In one embodiment, the elevated design on the lower surface of the sub-layer of the underlay sheet is made as a relief comprising separate elevated patterns which may vary in form and in which the hardness of a pattern unit may differ from the plate-like part of the sub-layer.

In one embodiment of the invention, the projections are arranged on the sub-layer in the same step of the manufacture of the plate-like sub-layer, preferably in the compression step, i.e. the entire sub-layer is shaped in one step.

In one embodiment of the invention, projections are arranged on the sub-layer substantially after the actual step of manufacture of the plate-like sub-layer, preferably after the compression step, i.e. the sub-layer is shaped in two steps. In one embodiment, the projections can be formed on the sub-layer in two steps, one part in conjunction with the compression step of the plate-like sub-layer, and the other part substantially after the compression step. The projections can be formed on the sub-layer afterwards e.g. by means of heat treatment.

In one embodiment, the film layer is arranged on the surface of the sub-layer substantially in conjunction with the step or steps of manufacture of the sub-layer. In one embodiment, the film layer is arranged on the surface of the sub-layer after the steps of manufacture of the sub-layer. In one alternative embodiment, the film layer is arranged on the surface of the sub-layer between the steps of manufacture of the sub-layer. The film layer is preferably arranged on the surface of the sub-layer by means of heat treatment.

In one embodiment, a gap is left between the wall and the floor covering, and the underlay sheet and the floor moulding in conjunction with the mounting of the underlay sheet to enable the air flow.

The solution in accordance with the invention enables a functional floor solution, comprising, between the base structure of the floor and the floor covering, an underlay sheet enabling the removal of moisture under the covering of the floor, and therefore the prevention of growth of harmful mildew between the floor structures, as well as the prevention of harmful effects on the covering of the floor caused by moisture. Thanks to the invention, the air between the supporting base structure of the floor and the underlay sheet is able to change, and moisture in the air is removed from the intermediate space due to the flow channels of the underlay sheet and e.g. from the gaps arranged on the edges of the floor. The removal of air is achieved by the elastic underlay sheet structure in accordance with the invention, in which for example walking produces a so-called pumping effect, causing the air to be removed from the intermediate space.

The underlay sheet in accordance with the invention evens out the irregularities of the supporting base structure, e.g. a concrete structure, of the floor. Moreover, the underlay sheet insulates the floor covering from the base structure, insulating also the effects of moisture on the surface structure of the floor and the sounds of footsteps on the base structure.

The composite material in accordance with the invention provides a vapour-barrier-level moisture insulation effect.

The underlay sheet in accordance with the invention is easy and affordable to manufacture. The underlay sheet has a uniform structure and it does not comprise separate films that should be mounted separately. Moreover, the sub-layer of the underlay sheet is substantially made from the same material, so that no additional material is needed for the projections. The underlay sheet in accordance with the invention is easy, quick and simple to mount at the desired application site.

A further advantage of the invention is that it provides good sound insulation to the floor.

### DETAILED DESCRIPTION OF THE INVENTION

In the following section, the invention will be described with the aid of detailed exemplary embodiments, referring to the accompanying drawings.

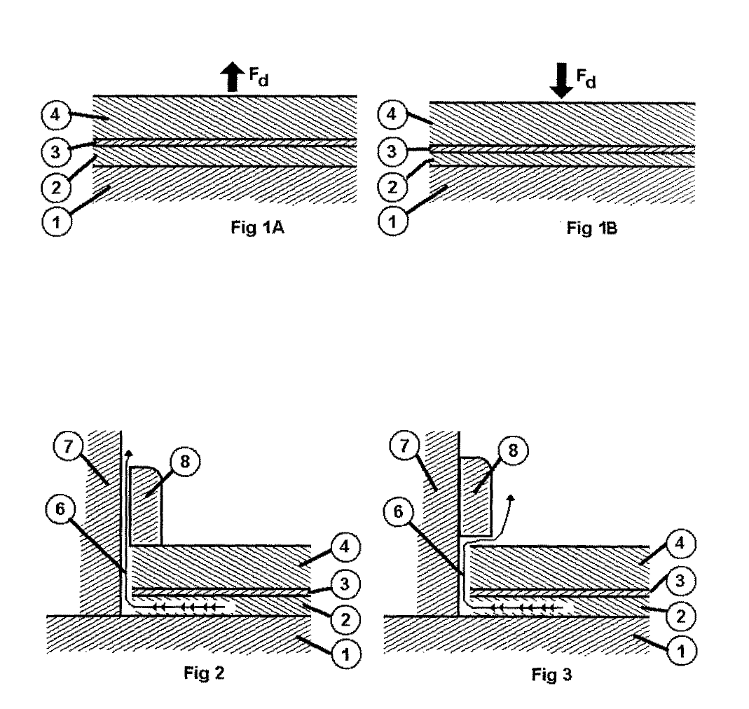

FIG. 1A represents the underlay sheet in accordance with the invention in the structure of the floor in a non-load carrying state;

FIG. 1B represents the operational principle of the underlay sheet in accordance with the invention when carrying a load;

FIG. 2 represents the mounting of the underlay sheet in accordance with the invention and the floor covering near the wall;

FIG. 3 represents an alternative mounting of the underlay sheet in accordance with the invention and the floor covering near the wall;

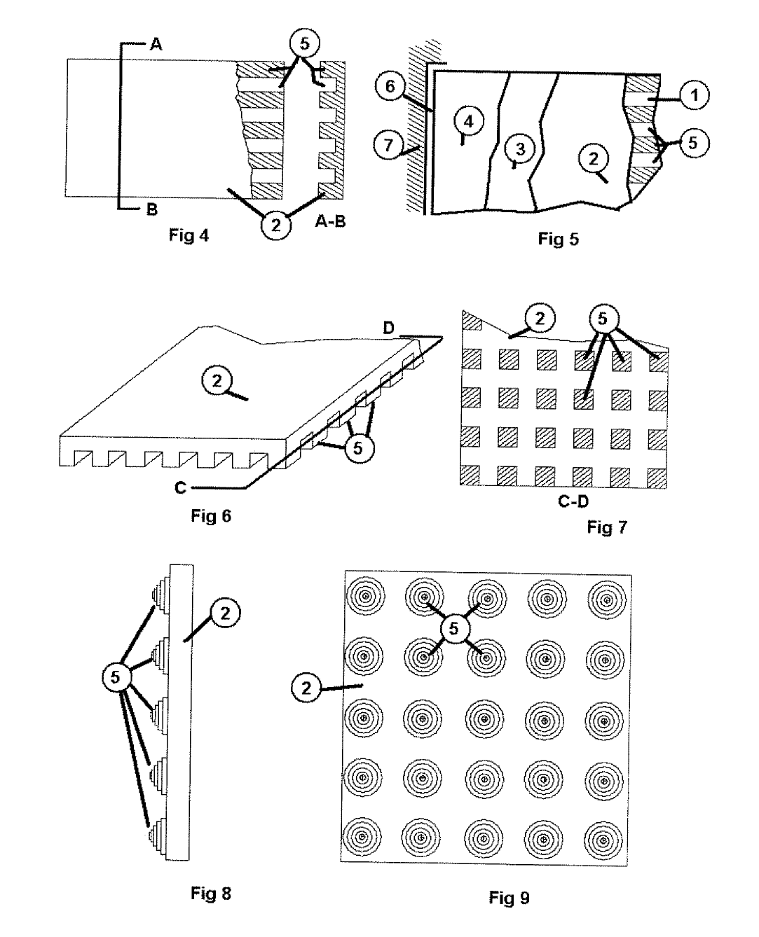

FIG. 4 represents a cross-section of the structure of the underlay sheet;

FIG. 5 represents the structure of the underlay sheet and its positioning in conjunction with the covering of the floor;

FIG. 6 represents an alternative structure of the underlay sheet as regards the air channel pattern of the lower surface;

FIG. 7 represents the pattern of the underlay sheet as seen from below;

FIG. 8 represents one alternative pattern for realizing the air channels in the underlay sheet; and

FIG. 9 represents one alternative pattern as seen from below.

FIG. lA presents the principle of placing the underlay sheet onto the structure of the floor. A sub-layer 2 of the underlay sheet is placed, as a flexible structure, onto the concrete bodywork 1. Mounted onto a tight-proof and thin multi-film layer 3 of about 20 μm in thickness which seals the air flow of the underlay sheet and insulates moisture is a floor covering 4 which is a laminate or a parquet. The figure shows the flexible cellular plastic structure 2 of the sub-layer and the tight-proof plastic film 3 insulating air and moisture as separate layers. In the underlay sheet structure in accordance with the invention, layers 2 and 3 of the underlay sheet are laminated together by means of heat to form a uniform structure. Manufacture of the underlay sheet by compression technique is known per se and is not described in any detail in this conjunction. The temperature is maintained at such level during the manufacture that the cells of the cellular plastic will be kept closed.

FIG. 1B represents the compression force caused by a load and resulting in compression of the cellular plastic layer 2 and in the pumping effect in the space between the cellular plastic 2 and the bodywork 1.

FIG. 2 represents the principle of air change in the structure of the floor covering. The flexible sub-layer 2 of the underlay sheet, placed onto the concrete bodywork 1, is provided with elevations 5, so that the air which changes through the air space between the elevations can be led into a gap 6 arranged at the edge of the floor. The air can be led into the room through the gap 6 between the wall 7 and the floor moulding 8. FIG. 3 represents an alternative structure for mounting the floor moulding 8.

The structure of the underlay sheet represented in FIG. 4 shows one possible form of the structure for the elevations 5 of the sub-layer 2. In this structure, the elevations 5 are formed into one-directional groove form on the lower surface of the sub-layer 2 of the underlay sheet. FIG. 5 represents the mounting design for mounting the floor covering using the above-presented underlay sheet.

FIGS. 6 and 7 represent a pattern for the elevations 5 on the lower surface of the sub-layer 2 of the underlay sheet in a cross-grooved form. FIGS. 8 and 9 represent one alternative pattern for the elevations 5.

It is possible to manufacture the underlay sheet in accordance with the invention in such manner that the underlay sheet 2 is laminated with the plastic film layer 3 directly against the lower surface of the floor covering 4.

The structure of the underlay sheet and the pattern of the elevations on the lower surface of the sub-layer may vary in details. Furthermore, the hardness of the underlay sheet will be formed as desired, taking into account the covering of the floor and the intended load.

The underlay sheet in accordance with the invention is suitable, in different embodiments, for use as the underlay sheet for different kinds of floor materials and floors.

The embodiments of the invention are not limited to the examples referred to above; instead many variations are possible within the scope of the accompanying claims.

1. An underlay sheet, characterized in that it is substantially a uniform structure, comprising two layers connected to each other, the first and upper layer (3) being a film layer, and the second and lower layer (2) being a sub-layer substantially formed of one material and comprising a plate-like part and projections (5) arranged on the lower surface of the plate-like part at a distance from each other and in accordance with a predetermined pattern, such that grooves for the air flow are formed between the projections.

2. The underlay sheet in accordance with claim 1, characterized in that the sub-layer (2) is formed of flexible cellular plastic.

3. The underlay sheet in accordance with claim 1, characterized in that the sub-layer (2) is formed of LDPE plastic.

4. The underlay sheet in accordance with claim 1, characterized in that the film layer (3) is formed of a thin plastic film.

5. The underlay sheet in accordance with claim 1, characterized in that a predetermined elevated pattern (5) is arranged on the lower surface of the sub-layer (2) of the underlay sheet.

6. The underlay sheet in accordance with claim 5, characterized in that the elevated pattern (5) is substantially regular.

7. A method for manufacturing an underlay sheet, characterized in that a plate-like sub-layer is formed of one material, suitable for the application, by compression, and projections are arranged on the lower surface thereof at a distance from each other in accordance with a predetermined pattern, such that grooves for the air flow are formed between the projections, and a film layer is arranged on the upper surface of the formed sub-layer and attached to the sub-layer by means of heat in order to form a uniform underlay sheet structure.

8. The method in accordance with claim 7, characterized in that the projections are arranged on the sub-layer in conjunction with the step of compressing the plate-like sub-layer.

9. The method in accordance with claim 7, characterized in that the projections are arranged on the sub-layer substantially after the step of compressing the plate-like sub-layer.

10. The method in accordance with claim 7, characterized in that the projections are formed on the sub-layer in two steps, one part in conjunction with the step of compressing the plate-like sub-layer, and the other part substantially after the compressing step.

11. The method in accordance with claim 7, characterized in that the film layer is arranged on the upper surface of the formed sub-layer substantially in conjunction with the manufacture of the sub-layer.

12. The method in accordance with claim 7, characterized in that the film layer is arranged on the upper surface of the formed sub-layer substantially after the manufacture of the sub-layer.

13. The method in accordance with claim 8, characterized in that the projections are arranged on the sub-layer substantially after the step of compressing the plate-like sub-layer.

14. The method in accordance with claim 8, characterized in that the projections are formed on the sub-layer in two steps, one part in conjunction with the step of compressing the plate-like sub-layer, and the other part substantially after the compressing step.

15. The method in accordance with claim 8, characterized in that the film layer is arranged on the upper surface of the formed sub-layer substantially in conjunction with the manufacture of the sub-layer.

16. The method in accordance with claim 8, characterized in that the film layer is arranged on the upper surface of the formed sub-layer substantially after the manufacture of the sub-layer.

17. The underlay sheet in accordance with claim 2, characterized in that the sub-layer (2) is formed of LDPE plastic.

18. The underlay sheet in accordance with claim 2, characterized in that the film layer (3) is formed of a thin plastic film.

19. The underlay sheet in accordance with claim 2, characterized in that a predetermined elevated pattern (5) is arranged on the lower surface of the sub-layer (2) of the underlay sheet.
